(19) United States
(12) Patent Application Publication
(10) Pub. No.: US 2006/0087126 A1
(43) Pub. Date: Apr. 27, 2006

(54) Latch assembly

(76) Inventor: Jerome P. Roussel, Colmar (FR)

Correspondence Address: CARLSON, GASKEY & OLDS, P.C., 400 WEST MAPLE ROAD, SUITE 350, BIRMINGHAM, MI, 48009, US

(21) Appl. No.: 11/247,967

(22) Filed: Oct. 11, 2005

(30) Foreign Application Priority Data
Oct. 26, 2004 (GB) 0423702.0

(51) Int. Cl. E05C 19/10

(52) U.S. Cl. 292/116

(57) ABSTRACT

A latch assembly includes a mouth for receiving a striker and a releasable latch bolt mechanism for automatically retaining the striker within the mouth. The mouth includes a deformable unitary jaw member defining opposing first and second jaw walls and an intermediate base portion. The jaw walls and the base portion are arranged to engage the striker. The base portion is configured to deflect inwardly upon receiving the striker. The inward deflection of the base portion causes a partial closure of the unitary jaw member by way of associated deflection of at least one of the jaw walls to reduce the distance between the jaw walls.

### REFERENCE TO RELATED APPLICATION

This application claims priority to United Kingdom Patent Application GB 0423702.0 filed on Oct. 26, 2004.

### BACKGROUND OF THE INVENTION

The present invention relates generally to a latch assembly for a vehicle and to a striker. More particularly, the present invention relates to a latch assembly including a latch and a striker having cooperating engagement means.

Light commercial vehicles, such as panel vans (i.e., vans in which a load space is enclosed), typically include a relatively large rear opening that is closeable by two rear doors hinged to a rear most edge of each side of the van. A latch is typically provided partially up a shut-face of one of the rear doors. The latch is arranged to latch with a complementary striker provided on the shut-face of the other of the rear doors when the doors are closed. Typically, the latch may also operate shoot bolts or supplementary latches which are fitted to upper and lower edges of the door to which the latch is fitted and which are arranged to engage in a complementary hole or a striker in a door surround. The shoot bolts or supplementary latches provide additional latching strength to the doors when closed to resist flexing of the relatively tall doors when the vehicle is in motion and to resist any attempts to force the latched doors open.

For the hingeable mounting to function, axes of the typically two hinges used to mount each door must be co-axially arranged. The sides of such vans often converge towards the van roof, meaning that it may be necessary to mount the hinges some distance below the top of the shut-face of each door. Furthermore, a significant proportion of the structural integrity of the rear of the van load space is imparted by the rear doors when shut. Thus, with the rear doors open, a certain amount of deflection of the roof and the side panels of the rear load space may occur, and a certain amount of flexing of the doors may also occur. Wear can also occur to the hinges over extended periods of use. The combination of these factors may lead to difficulties in locating the latch with the striker and/or the shoot bolts in the respective holes due to movement of the rear doors out of their proper alignment. This may in turn lead to difficulties in satisfactorily latching the doors.

Additionally, the deflection of the roof, the side panels and the doors while the vehicle is in motion may lead to rattling caused by play between the latch and the striker. This may in turn lead to increased wear on both the latch and the striker, as well as higher noise levels.

It has been proposed to overcome these problems by introducing an assembly within the mouth of the latch which attempts to grip (but not retain) the striker when the striker is in a closed position. Such an embodiment is shown in EP0723620. However, displacement of the gripping assembly inwardly into the body of the latch is necessary for the assembly to grip the striker. Furthermore, several distinct components are required to achieve the gripping of the striker, which further adds to the cost and complexity of the latch.

The present invention seeks to overcome, or to at least mitigate, the problems of the prior art.

### SUMMARY OF THE INVENTION

Accordingly, one aspect of the present invention provides a latch assembly including a mouth for receiving a striker and a releasable latch bolt mechanism for automatically retaining the striker within the mouth. The mouth includes a deformable unitary jaw member defining opposing first and second jaw walls and an intermediate base portion. The first and second jaw walls and the base portion are arranged to engage the striker. The base portion is configured to deflect inwardly upon receiving the striker. The inward deflection of the base portion causes a partial closure of the unitary jaw member by way of associated deflection of at least one of the first and second jaw walls to reduce a distance between the first and second jaw walls.

A second aspect of the present invention provides a striker assembly for a latch mechanism having a striker bar attached to a striker support and an overmold arranged to cover a part of the striker bar and a part of the striker support. The overmold is arranged to engage the striker bar and the striker support to prevent rotation of the overmold relative to the striker support.

A third aspect of the invention provides the latch assembly of the first aspect of the invention and the striker assembly of the second aspect of the invention. The striker overmold and the inner surfaces of the unitary jaw member are dimensioned such that when the striker bar is retained by the latch bolt, the first and second jaw walls compress the overmold.

### BRIEF DESCRIPTION OF THE DRAWINGS

Embodiments of the present invention will now be described, by way of example only, with reference to the accompanying drawings in which:

FIG. 1 is a partially exploded isometric view of the latch assembly according to a first aspect of the invention;

FIG. 2 is an isometric view of the latch assembly of FIG. 1 showing the opposite side of the latch assembly to that shown in FIG. 1;

FIG. 3 is a side view of the latch assembly of FIG. 1, showing hidden detail;

FIG. 4 is an isometric view of a striker of the second aspect of the invention;

FIG. 5 is an isometric view of the striker of the second aspect of the present invention showing the deformable unitary door member of the first aspect of the invention;

FIG. 6 is a partially exploded isometric view of the latch assembly of FIG. 1 showing part of the striker of FIG. 4 in the closed position; and

FIG. 7 is a side view of the latch assembly of FIG. 3 showing part of the striker of FIG. 4.

### DETAILED DESCRIPTION OF THE PREFERRED EMBODIMENT

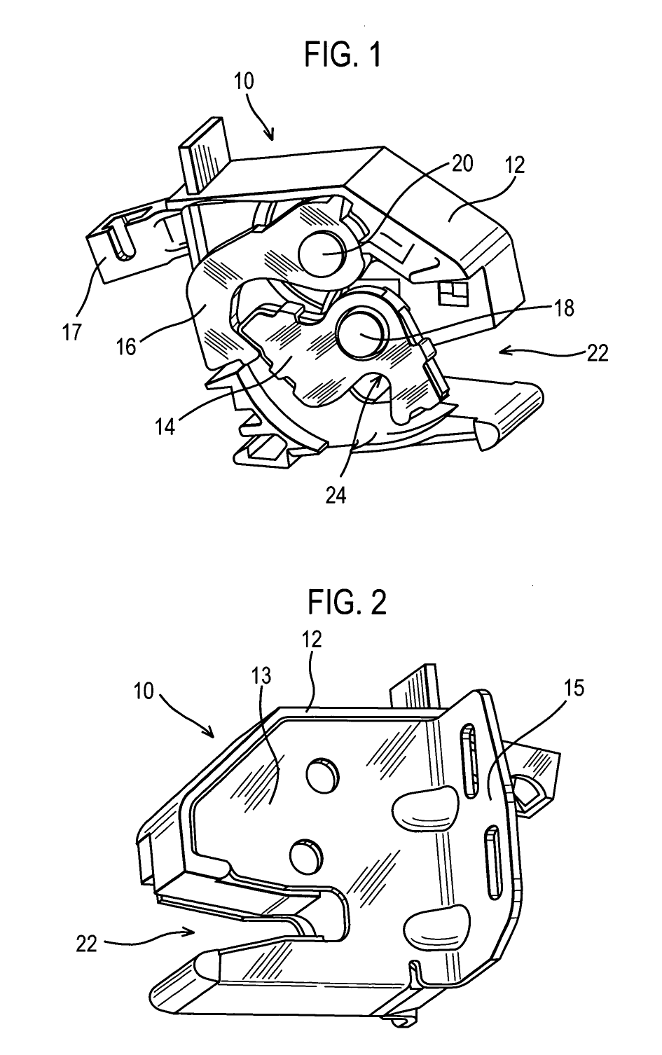

FIGS. 1 and 2 illustrate a latch assembly 10 including a latch chassis 12 on which a latch bolt in the form of a rotatable claw 14 and a pawl 16 are pivotally mounted. The pawl 16 is typically in driven engagement with a latch operator, such as an inside release handle of a vehicle door to which the latch assembly 10 is mounted, either directly or more usually indirectly, via a primary latch (not shown) itself controlled by an inside handle and/or an outside handle. The primary latch has an output to the pawl 16 via a bowden cable or the like (not shown) and a release lever 17.

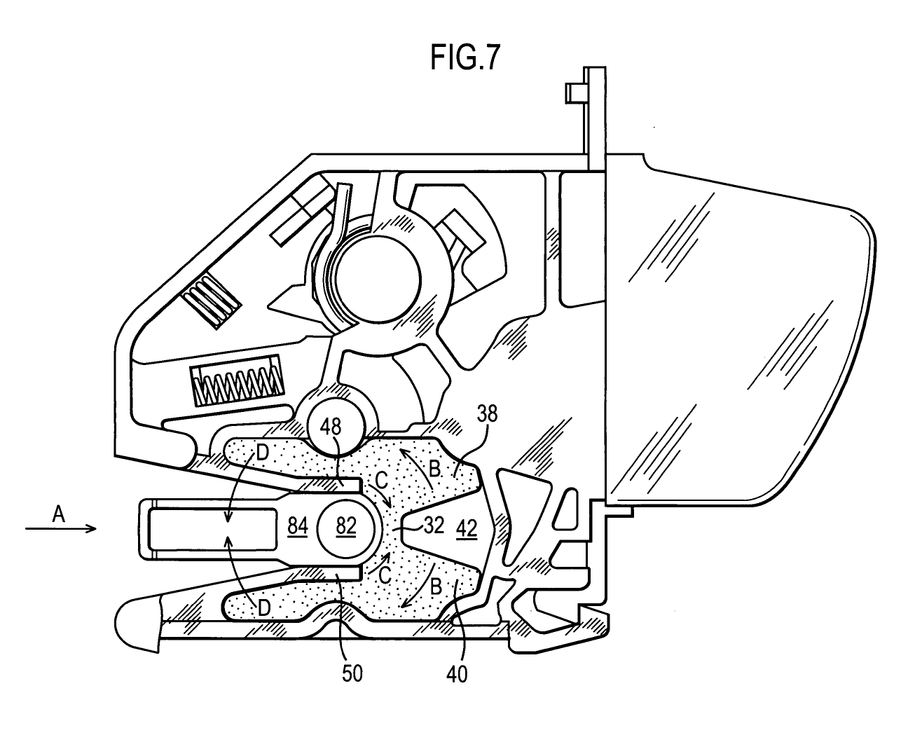

FIG. 1 shows the latch assembly 10 in a closed latched position with the claw 14 configured to retain a striker bar 82 of a striker assembly 70 within a claw recess 24 (see FIG. 7). The claw 14 is retained in a closed position by the pawl 16. The pawl 16 may be lifted by the release lever 17 to release the claw 14.

The sides of the latch chassis 12 are enclosed by side plates 13 which define latch mount plates 15. The latch chassis 12 and the side plates 13 define a mouth 22 for receiving the striker bar 82, thereby allowing the striker to be retained in the claw recess 24 in the closed position by engagement of the pawl 16 with the claw 14 (as shown in FIG. 1).

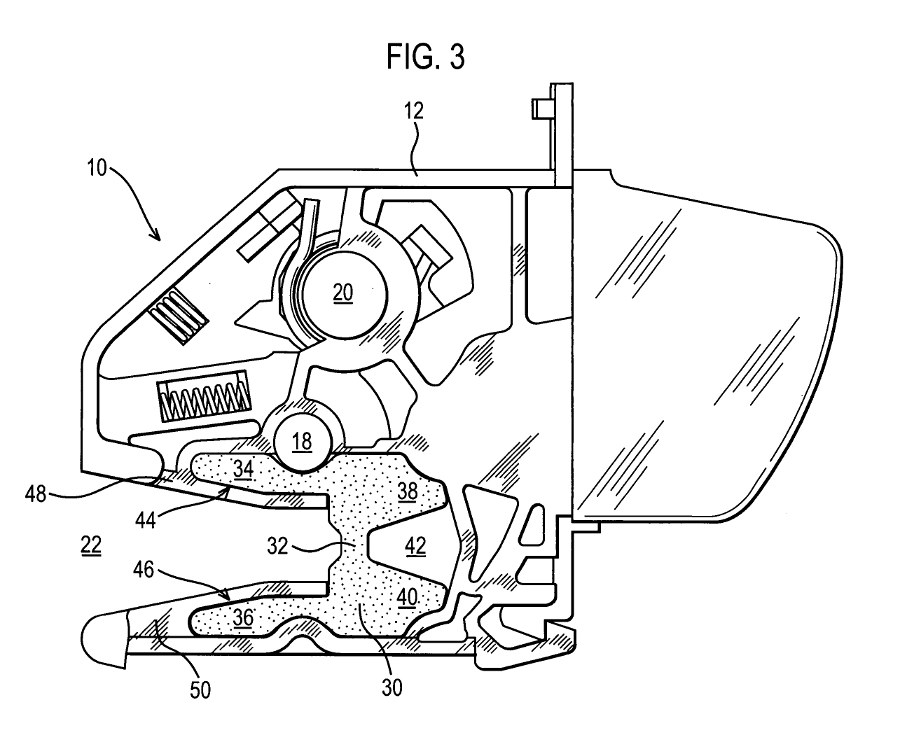

With reference now to FIG. 3, the mouth 22 of the latch assembly 10 houses a jaw member 30. The jaw member 30 is of unitary construction and is formed from a deformable plastics material (e.g., a nitrile rubber). However, the jaw member 30 can be formed from any material having suitable plastic properties. The jaw member 30 includes an upper jaw wall 34 and a lower jaw wall 36 which extend outwardly from a base portion 32. A upper leg 38 and a lower leg 40 extend inwardly from the base portion 32. The jaw member 30 is advantageously symmetrical and can be used for both upper and lower supplementary latches without adaptation.

The inner profile of the latch chassis 12 and the outer profile of the upper leg 38 and the upper leg 40 define a deflection cavity 42 which allows the base portion 32 to deflect inwardly (i.e., away from mouth 22), as will be discussed further below.

The upper jaw wall 34 and the lower jaw wall 36 define an inner surface 44 and 46, respectively. Abutting the inner surfaces 44 and 46 are a first striker guide 48 and a second striker guide 50 which are provided to protect the upper jaw wall 34 and the lower jaw wall 36, respectively, and also be of lower friction than the jaw member 30 to reduce the latching effort required. The first striker guide 48 and the second striker guide 50 guide an associated striker towards the base portion 32, as will be discussed in further detail below. The first striker guide 48 and the second striker guide 50 are advantageously formed integrally from the same material as the latch chassis 12, which as described above also houses and supports the claw 14, the pawl 16, the springs and the like. The first striker guide 48 and the second striker guide 50 may be made from any suitable engineering plastics such as PBT, and their cantilevered shape makes them relatively flexible.

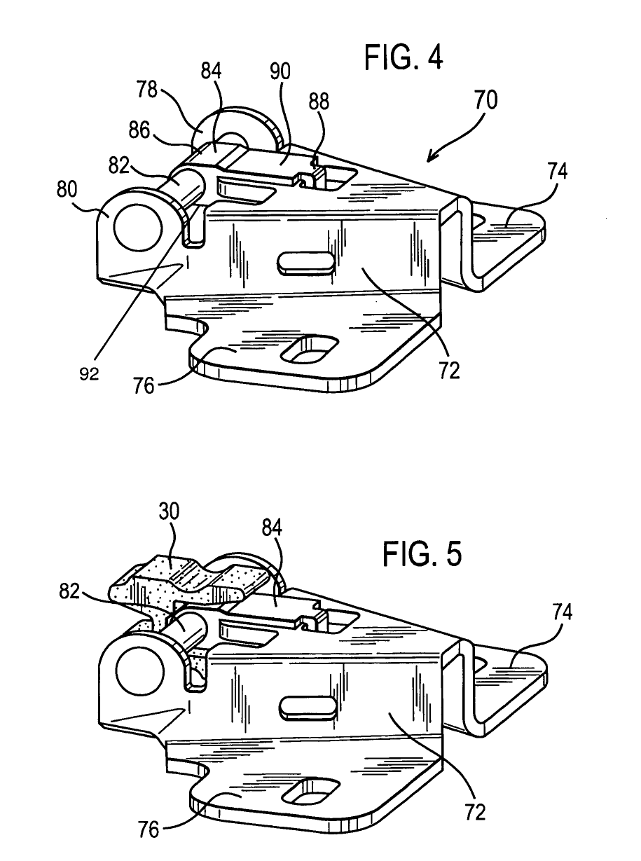

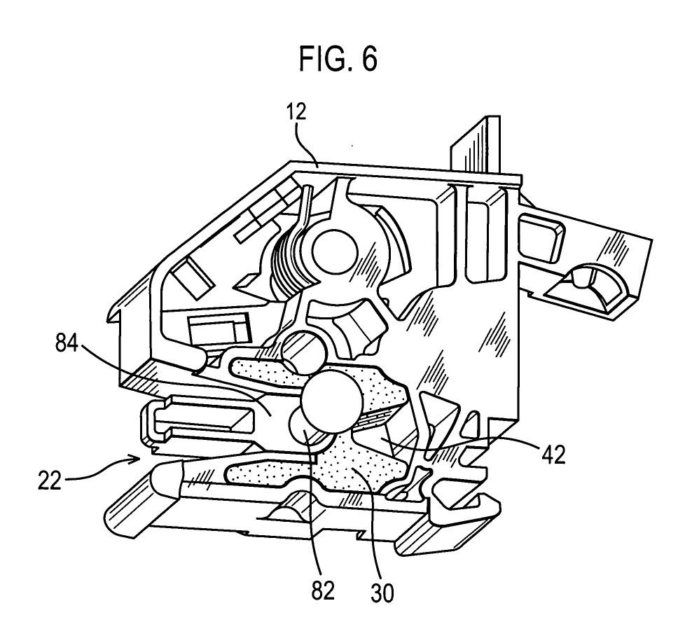

With reference now to FIG. 4, the striker assembly 70 includes a main body 72 formed from a unitary pressed steel sheet, a first striker mount plate 74, a second striker mount plate 76, a first support arm 78 and a second support arm 80. The first support arm 78 and the second support arm 80 support the striker bar 82. A striker overmold 84 covers part of the striker bar 82 and part of the main body 72. The striker overmold 84 has a first end 86, and second end 88, an upper surface 90 and a lower surface 92 (only the upper surface 90 is visible in FIGS. 5 and 6). The striker overmold 84 is preferably resilient and may be made from a suitable thermoplastic elastomer or the like. The remainder of the striker bar 82 is left bare to be engaged by the claw 14.

In use, the latch assembly 10 and the striker assembly 70 will cooperate as follows. The striker assembly 70 is attached by way of the first striker mount plate 74 and the second mount striker plate 76 to a vehicle door surround (not shown for clarity). The latch assembly 10 will be fixed by way of the side plate 13 to a vehicle door (also not shown for clarity). Typically, the vehicle will be a panel van, and the latch assembly 10 will operate as a supplementary latch to a primary latch and be secured near an upper edge or a lower edge of a rear door. The striker assembly 70 will be secured near the load floor or the roof of the rear of the van. The striker assembly 70 is typically arranged such that the striker bar 82 is substantially horizontal (i.e., at 90 degrees to the axis of the door hinges), but this need not necessarily be the case. The latch assembly 10 is typically arranged such that an axis of rotation of the claw 14 is substantially horizontal. The latch assembly 10 is oriented as shown in the drawings when positioned near the bottom of the door and will be inverted when positioned near the top of the door.

When the vehicle door is closed, the striker bar 82 and the striker overmold 84 are initially received in the mouth 22 of the latch assembly 10. As the door is moved further to a closed position, the first end 86 of the striker overmold 84 comes into contact with the base portion 32 of the jaw member 30, as shown in FIGS. 5 and 6. Final movement of the door causes the striker bar 82 to move further inwardly into the mouth 22 of the latch assembly 10. This movement causes deflection of the jaw member 30, as will be discussed further shortly. The deflection of the jaw member 30 allows the striker bar 82 to move inwardly, which in turn allows the claw 14 to automatically catch the striker bar 82 within the claw recess 24. Since the claw 14 is retained by the pawl 16, the striker bar 82 is held in the closed position. This leaves the jaw member 30 in a permanent state of deflection once the striker bar 82 is held in the closed position. This deflection causes the jaw member 30 to compress the striker overmold 84 to reduce movement thereof in the following manner.

With reference to FIG. 7, closing the vehicle door causes the striker bar 82 and the striker overmold 84 to move in direction A towards the base portion 32. This causes the base portion 32 to deflect into the deflection cavity 42. In turn, this causes the compression of the inner portions of the upper leg 38 and the lower leg 40, which causes migration of the material forming the upper leg 38 and the lower leg 40 in the direction of arrows B. In addition, deflection of the base portion 32 in the direction A causes a load to be applied to the base of the upper jaw wall 34 and the lower jaw wall 36 in the direction of arrows C. The net effect of the loading on the jaw member 30 causes the upper jaw wall 34 and lower jaw wall 36 to be urged towards one another in the direction of arrows D. Consequently, the upper jaw wall 34 and the lower jaw wall 36 apply a load to the striker overmold 84 via the first striker guide 48 and the second striker guide 50.

This load acts to “grip” the striker bar 82 and the striker overmold 84 to reduce relative movements between the striker assembly 70 and the latch assembly 10 in the so-called Z-direction (i.e., vertically) when the latch and the striker are fitted in either of the orientations described above.

When the pawl 16 is disengaged from the claw 14 to release the latch assembly 10, the compressed nature of the striker bar to jaw member relationship promotes the movement of the striker bar 82 out of the mouth as the potential energy in the jaw member 30 is released.

The latch assembly 10 of the present invention could be used in conjunction with a striker assembly different from that described herein. Such an arrangement would still offer benefits over the prior art devices. However, the combination of the striker assembly 70 and the latch assembly 10 as described in the present invention confers substantial advantages over the prior art for the following reasons.

There exists a large area of surface contact between the upper surface 90 and the lower surface 92 of the striker overmold 84 and the first striker guide 48 and the second striker guide 50, respectively. This increases the level of grip achieved between the latch assembly 10 and the striker assembly 70, which further reduces the extent of the movement realized between the two assemblies.

Additionally, the construction of the striker assembly 70 means that there is virtually no rotation of the striker overmold 84 with respect to the vehicle door. This ensures that a secure connection exists between the latch assembly 10 and the striker assembly 70, which further decreases the relative movement observed between the latch assembly 10 and the striker assembly 70.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A latch assembly comprising:
a mouth for receiving a striker, the mouth including a deformable unitary jaw member defining a first jaw wall, an opposing second jaw wall and an intermediate base portion, wherein the first jaw wall, the opposing second jaw wall, and the intermediate base portion are arranged to engage the striker, and wherein the intermediate base portion deflects inwardly upon receiving the striker to cause a partial closure of the deformable unitary jaw member by way of an associated deflection of at least one of the first jaw wall and the opposing second jaw wall to reduce a distance between the first jaw wall and the opposing second jaw wall; and
a releasable latch bolt mechanism for automatically retaining the striker within the mouth.

2. The latch assembly according to claim 1 wherein the deformable unitary jaw member includes a first leg and a second leg arranged on a side of the intermediate base portion opposite to the first jaw wall and the opposing second jaw wall, and the first leg and the second leg define a deflection cavity therebetween.

3. The latch assembly according to claim 2 wherein the first leg and the second leg partially compress upon deflection of the intermediate base portion when receiving the striker.

4. The latch assembly according to claim 2 wherein the intermediate base portion partially deflects into the deflection cavity when the intermediate base portion receives the striker.

5. The latch assembly according to claim 1 wherein each of the first jaw wall and the opposing second jaw wall include an inner surface which defines a striker receiving region proximate the intermediate base portion.

6. The latch assembly according to claim 5 wherein the striker receiving region of each of the first jaw wall and the opposing second jaw wall are substantially straight.

7. The latch assembly according to claim 6 wherein the striker receiving region of each of the first jaw wall and the opposing second jaw wall are substantially parallel.

8. The latch assembly according to claim 1 further including a first striker guide and a second striker guide arranged to cover the first jaw wall and the opposing second jaw wall, respectively, to guide the striker towards the intermediate base portion.

9. The latch assembly according to claim 8 wherein each of the first jaw wall and the opposing second jaw wall include a wall inner surface which defines a striker receiving region proximate the intermediate base portion, and each of the first striker guide and the second striker guide includes a guide inner surface which is substantially parallel to the wall inner surface of the first jaw wall and the opposing second jaw wall, respectively.

10. A striker assembly for a latch mechanism comprising:
a striker bar attached to a striker support; and
an overmold arranged to cover a part of the striker bar and a part of the striker support, wherein the overmold engages the striker bar and the striker support to prevent rotation of the overmold relative to the striker support.

11. The striker assembly according to claim 10 wherein the striker bar includes a first striker bar end and a second striker bar end and the striker support includes a main body, a mount plate, and two striker support arms, wherein the main body is carried on the mount plate, the two striker support arms are attached to the main body, and the two striker support arms retain the first striker bar end and the second striker bar end of the striker bar, respectively.

12. The striker assembly according to claim 11 wherein the overmold extends from the striker bar towards the main body.

13. The striker assembly according to claim 12 wherein the overmold includes a first overmold end and a second overmold end, and the first overmold end is attached to the striker bar and the second overmold end is fixed to the main body.

14. The striker assembly according to any claim 13 wherein the overmold includes a first side and a second side which extend between the striker bar and the main body.

15. The striker assembly according to claim 14 wherein the first side and the second side are substantially straight.

16. The striker assembly according to claim 15 wherein the first side and the second side are substantially parallel.

17. A latch comprising:
a latch assembly including:
a mouth for receiving a striker, the mouth including a deformable unitary jaw member defining a first jaw wall, an opposing second jaw wall and an intermediate base portion, wherein the first jaw wall, the opposing second jaw wall and the intermediate base portion are arranged to engage the striker, and the intermediate base portion deflects inwardly upon receiving the striker to cause a partial closure of the deformable unitary jaw member by way of an associated deflection of at least one of the first jaw wall and the opposing second jaw wall to reduce a distance between the first jaw wall and the opposing second jaw wall, and
a releasable latch bolt mechanism for automatically retaining the striker within the mouth; and
a striker assembly including:
a striker bar attached to a striker support, and
an overmold arranged to cover a part of the striker bar and a part of the striker support, wherein the overmold engages the striker bar and the striker support to prevent rotation of the overmold relative to the striker support,
wherein the overmold and an inner surface of the inner jaw wall and the opposing second jaw wall are dimensioned such that the inner jaw wall and the opposing second jaw wall compress the overmold when the striker bar is retained by the releasable latch bolt mechanism.
